(19) United States
(12) Patent Application Publication
(10) Pub. No.: US 2006/0255517 A1
(43) Pub. Date: Nov. 16, 2006

(54) Shock isolation system for electronic devices

(76) Inventors: Gwo-Shiang Lee, Taipei (TW); Wei-Chin Chen, Taipei (TW); Chuang-Ching Kang, Tainan (TW); Ching-Fang Ho, Taichung (TW)

Correspondence Address: HARNESS, DICKEY & PIERCE, P.L.C., P.O. BOX 8910, RESTON, VA, 20195, US

(21) Appl. No.: 11/199,076

(22) Filed: Aug. 9, 2005

(30) Foreign Application Priority Data
May 13, 2005 (TW) 94115689

(51) Int. Cl. F16F 1/36

(52) U.S. Cl. 267/148

(57) ABSTRACT

A shock isolation system for electronic devices includes a first baseboard, a second baseboard and a plurality of helical springs interposed transversely between the first baseboard and the second baseboard. The helical springs can deform horizontally and vertically to isolate horizontal and vertical vibration-impact on the electronic devices. The first baseboard and the second baseboard further are bridged by a plurality of damping elements, which have damping characteristics to dissipate kinetic energy and reduce the vibration amplitude and instantaneous acceleration between the first baseboard and the second baseboard, thereby to enhancing the composite effect. The first baseboard further has a plurality of buffer struts to separate the first baseboard and the second baseboard, and prevent the second baseboard from directly hitting the first baseboard.

### BACKGROUND OF THE INVENTION

1. Field of Invention

The present invention relates to shock and/or vibration isolation and protection of electronic devices and particularly to a shock and/or vibration isolation system for an electronic device mounting onto an automotive vehicle.

2. Related Art

Notebook computers used in industry or military often have to be operated in a harsh environment. For instance, for a notebook computer located on industrial machinery, because the machinery generates mechanical shock and/or vibration during operation, operation of the hard disk in the computer is affected. Other elements also constantly receive stress due to acceleration. As a result, disconnection might happen or the elements could be damaged. The notebook computers used in military encounters even worse conditions. They often have to be operated on automotive vehicles. The road condition could be rough and vibration could occur constantly. The vibration amplitude and frequency are unpredictable. Pits or bumps on the road could generate huge vibration and impact. On the other hand, the sea or airborne vehicles have different types of vibrations. In order to function in such circumstances, the military-use notebook computer, besides conforming to a stricter specification for withstanding a greater vibration and impact, also has to adopt a shock and/or vibration absorbing apparatus to isolate shock and/or vibration and cushion impact. By means of this approach, the military-use notebook computer can be held in a mobile carrier to isolate and absorb external shock and/or vibrations, and function as desired.

Refer to FIG. 1 for a “Shock reducing rack” disclosed in R.O.C. patent application No. 090221805. It includes an upper baseboard 1, a lower baseboard 2 and a plurality of elastic columns 3. The upper baseboard 1 aims to hold a notebook computer 4. The lower baseboard 2 is mounted onto a vibration source (such as industrial machinery, an automotive vehicle or the like). The elastic columns 3 are located between the upper baseboard 1 and the lower baseboard 2, and can deform elastically to isolate shock and/or vibrations. However, the upright elastic columns 3 have a limited capability to isolate horizontal vibrations. The damping effect of the elastic columns 3 also is limited. After compression, instantaneous release of elastic potential energy generates an acceleration that could produce a secondary impact. R.O.C. patent application No. 091204948 discloses a “hybrid shock absorbing apparatus” that includes a horizontal shock-absorbing unit located above a vertical shock-absorbing unit. The vertical shock-absorbing unit consists of springs to isolate shock and/or vibration in the vertical direction. The horizontal shock-absorbing unit mainly includes an elastic member, which is deformable in horizontal direction to isolate the horizontal vibration. However, the apparatus disclosed in 091204948 still has a secondary impact in the vertical direction or horizontal direction. The shock absorbing effect is limited.

Refer to FIG. 2 for “Portable office having a removable computer workstation and shock isolation means therefore” disclosed in U.S. Pat. No. 6,229,698. It includes a base plate 5 and a loading body 6 bridged by a plurality of helical springs 7, which have long axes positioned horizontally. The helical springs 7 are deformable elastically in the axial or radial direction to absorb shock and/or vibrations in the horizontal and vertical directions. But its physical characteristics mainly depend on the elastic alteration and the damping effect is poor. While it can prevent an instantaneous impact, great vibration amplitude will still be generated. Moreover, when the helical springs 7 are compressed, an elastic force is generated to produce a secondary impact. Hence the practical effect is limited.

### SUMMARY OF THE INVENTION

The conventional shock and/or vibration isolation apparatus provides shock and/or vibration isolation protection through elastic elements, such as springs. They have limited damping characteristics, and when the elastic elements are compressed, elastic potential energy will be released to generate a secondary impact. The shock and/or vibration isolation effect suffers.

Hence the primary object of the invention is to provide a shock and/or vibration isolation system for electronic devices that can buffer instantaneous acceleration and dissipate kinetic energy through damping characteristics, to prevent damages that might occur to electronic devices, caused by the secondary impact generated by the compressed helical springs.

Another object of the invention is to provide a shock and/or vibration isolation system for electronic devices that provides a second level shock and/or vibration isolation protection to prevent excessive instantaneous acceleration and vibration amplitude, and enable the shock and/or vibration isolation apparatus to function normally.

In order to achieve the foregoing objects, the shock and/or vibration isolation system for electronic devices of the invention includes a first baseboard mounting onto a vibration source, a second baseboard located above the first baseboard at a selected distance to hold an electronic device, such as a notebook computer or industrial computer, a plurality of helical springs located between the first baseboard and the second baseboard with lateral sides to bridge the first baseboard and the second baseboard, and a plurality of damping elements which have two ends connecting to the second baseboard and the first baseboard.

By means of the construction set forth above, when the first baseboard receives shock and/or vibrations generated by a vibration source, the helical springs deform elastically to transform the shock and/or vibrations to elastic potential energy to protect the second baseboard and the electronic device against the direct impact of the shock and/or vibrations. The damping elements dissipate kinetic energy while the helical springs deform thereby, to further absorb the shock and/or vibrations and prevent the helical springs from generating excessive high speed and acceleration during initial restoration, thus can avoid the secondary impact on the second baseboard.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus is not limitative of the present invention, wherein:

FIG. 1 is a perspective view of a conventional shock and/or vibration isolation apparatus;

FIG. 2 is a perspective view of another conventional shock and/or vibration isolation apparatus;

FIG. 3 is an exploded view of an embodiment of the invention;

FIG. 4 is a perspective view of the embodiment of the invention;

FIG. 5 is a fragmentary perspective view of the embodiment of the invention showing the damping elements and holding plates;

FIGS. 6A through 6C are schematic views of the embodiment of the invention showing the damping elements in various operating conditions;

FIGS. 7A and 7B are schematic views of the embodiment of the invention showing the helical springs and buffer struts in various operating conditions; and

FIG. 8 is a schematic view of another embodiment of the invention.

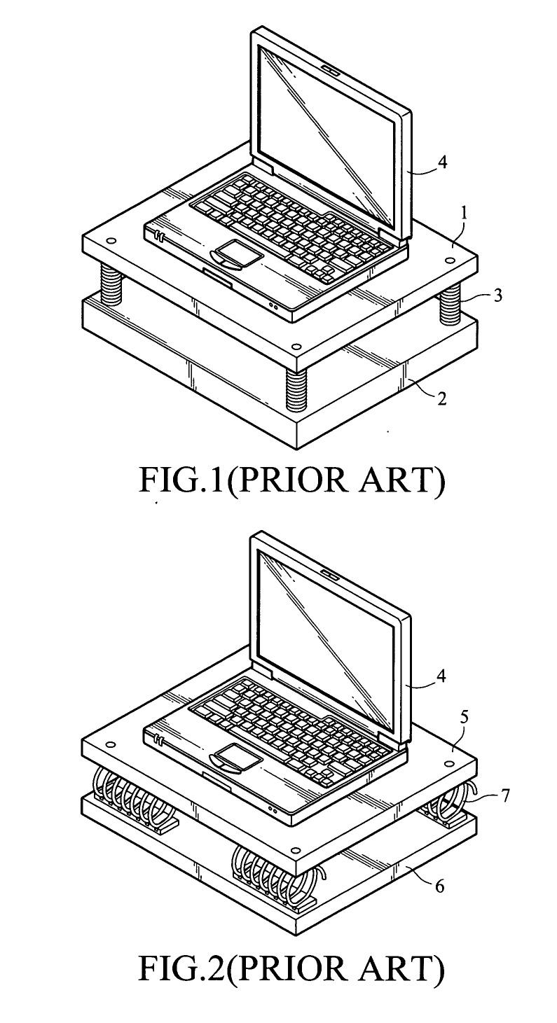

### DETAILED DESCRIPTION OF THE INVENTION

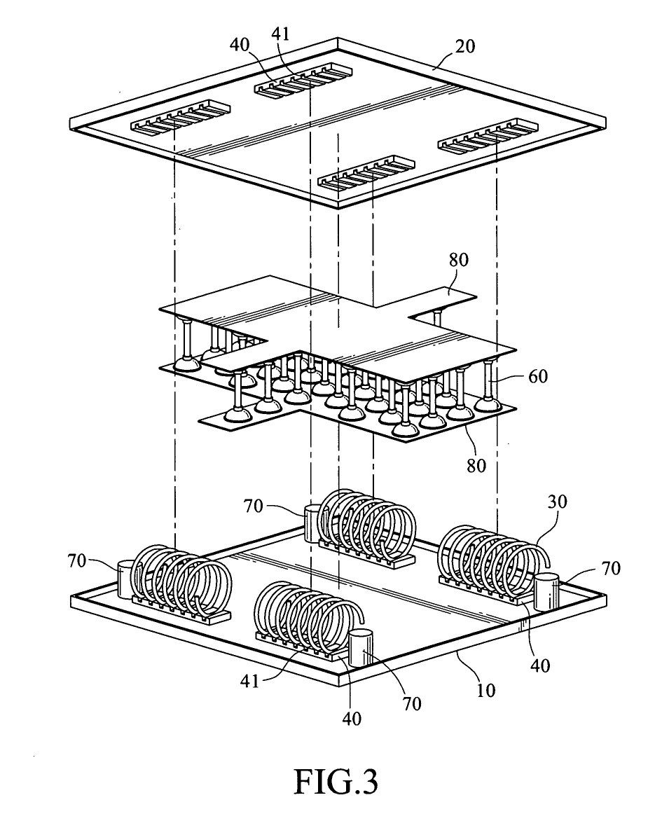

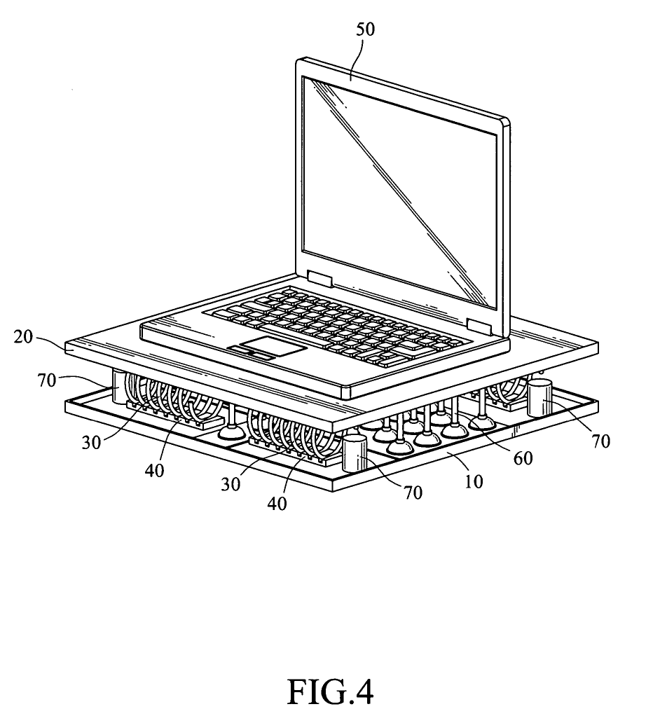

Refer to FIGS. 3 and 4 for an embodiment of the shock isolation system for electronic devices of the invention. It aims to hold an electronic device, which is sensitive to shock and/or vibration, such as a notebook computer, and isolate the electronic device from a vibration source. By providing an improved elastic and damping effect, impact on, or excessive displacement vibration of the electronic device can be prevented so that damage of electronic elements in the electronic device or breaking of contacts between the elements can be avoided.

The shock isolation system for electronic devices according to the invention includes a first baseboard 10, a second baseboard 20, a plurality of helical springs 30, and a plurality of holding elements 40.

The first baseboard 10 is a rectangular plate mounted onto a vibration source, such as a motor vehicle, ship or a platform of large machinery to receive a shock and/or vibration impact generated by the vibration source.

The first baseboard 20 is a rectangular plate located above the first baseboard 10 in a parallel manner, and is spaced from the first baseboard 10 at a selected distance. The second baseboard 20 aims to hold a electronic device 50, such as an industrial or military notebook computer.

The helical springs 30 are laid transversely between the first baseboard 10 and the second baseboard 20. The axes of the helical springs are parallel with the first baseboard 10 and the second baseboard 20. The helical springs 30 are made of steel coils, which can be deformed radially or turn axially in a torsional manner to absorb kinetic energy and transform it to elastic potential energy. Thereby, the helical springs 30 can achieve a shock and/or vibration isolation effect in the radial and axial directions.

The holding elements 40 are located on the first baseboard 10 and the second baseboard 20, formed in pairs and correspond to each other to hold the helical springs 30 so that the helical springs 30 can bridge the first baseboard 10 and the second baseboard 20. The helical springs 30 can be deformed elastically, radially and axially to provide a shock and/or vibration isolation effect for the first baseboard 10 in the horizontal or vertical direction. Each holding element 40 has a plurality of ditches 41, which have a width mating the wire diameter of the helical springs 30. Hence the helical coil of each helical spring 30 can be wedged in the ditch 41, to enable the lateral side of the helical spring 30 to be coupled on the holding element 40, and be anchored between the first baseboard 10 and the second baseboard 20.

While the shock and/or vibration isolation process occurs to the helical springs 30, the elastic deformation generates a relative displacement between the first baseboard 10 and the second baseboard 20 to isolate the instantaneous impact created by shock and/or vibration. Next, the elastic force returns the first baseboard 10 and the second baseboard 20 to their original positions to prevent the second baseboard 20 from receiving direct impact caused by the shock and/or vibration. Therefore damage to the electronic device 50 can be avoided.

As the damping characteristics of the helical springs 30 are negligible, and the effect of damping effect is limited, the vibration amplitude or acceleration could be too much when subject to an external impact. Moreover, when the helical springs 30 are deformed, the kinetic energy is transformed to elastic potential energy. When the elastic potential energy is released again to become kinetic energy, an instantaneous acceleration occurs. This generates a secondary impact to the electronic device 50 on the second baseboard 20. In addition, if the instantaneous impact exceeds the operation limit of the helical springs 30, the helical springs 30 could be permanently damaged and lose the elastic characteristic. Likewise, the second baseboard 20 hits the first baseboard 10 and damages the shock and/or vibration isolation protection effect.

To resolve the aforesaid issues, the invention further provides a plurality of damping elements 60 and buffer columns 70. The damping elements 60 have damping characteristics to dissipate kinetic energy. The buffer struts 70 can aid the helical springs 30 and prevent the helical springs from deforming excessively, thereby prevent contact between the first baseboard 10 and the second baseboard 20, and damage of the electronic device 50 on the second baseboard 20.

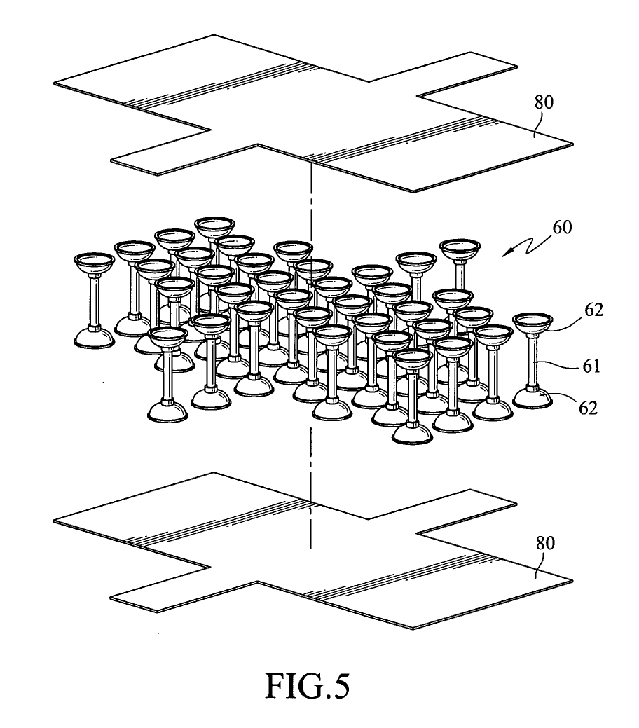

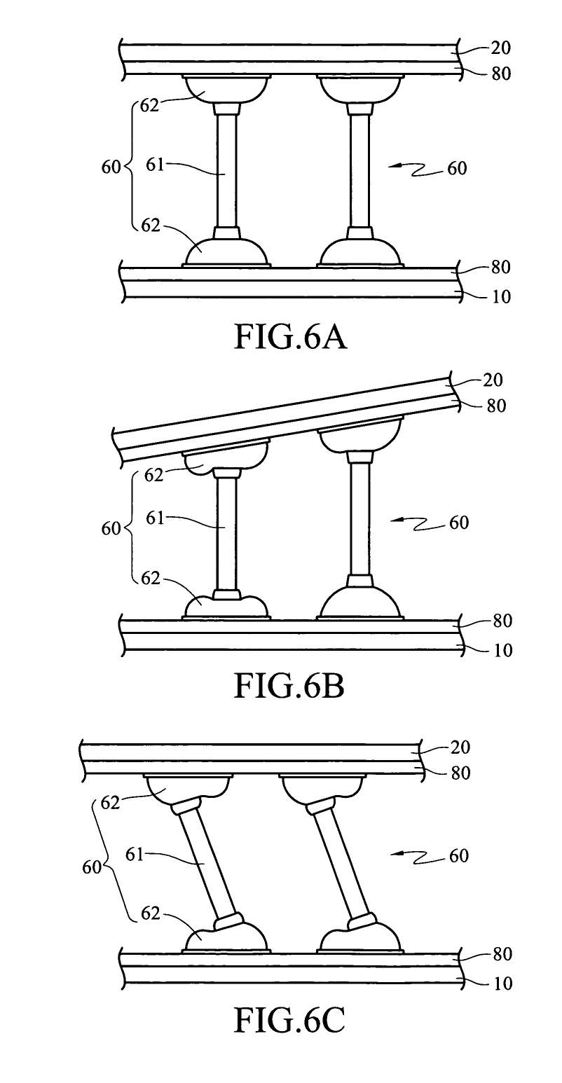

Referring to FIG. 5, each of the damping elements 60 consists of a linkage bar 61 and two damping rubber blocks 62 located on two ends of the linkage bar 61 to connect to the first baseboard 10 and the second baseboard 20. When the first baseboard 10 and the second baseboard 20 are subject to an external force and change the relative positions, in addition to the deformation occurring to the helical springs 30 that transform the kinetic energy to elastic potential energy, the damping elements 60 also can directly dissipate the kinetic energy. The damping rubber blocks 62 are deformed to absorb the kinetic energy and transform this to heat energy for dissipation. Thus shock and/or vibration energy received by the first baseboard 10 is directly absorbed, and an improved shock and/or vibration isolation effect can be achieved. Referring to FIGS. 6A through 6C, to facilitate installation of the damping elements 60, the invention further includes two holding plates 80. The damping elements 60 are mounted in advance between the two holding plates 80 to become a modular unit. Then the two holding plates 80 are sandwiched between the first baseboard 10 and the second baseboard 20 on two facing sides thereof. The holding plates 80 may be formed in a shape according to the layout of the damping elements 60 to facilitate installation.

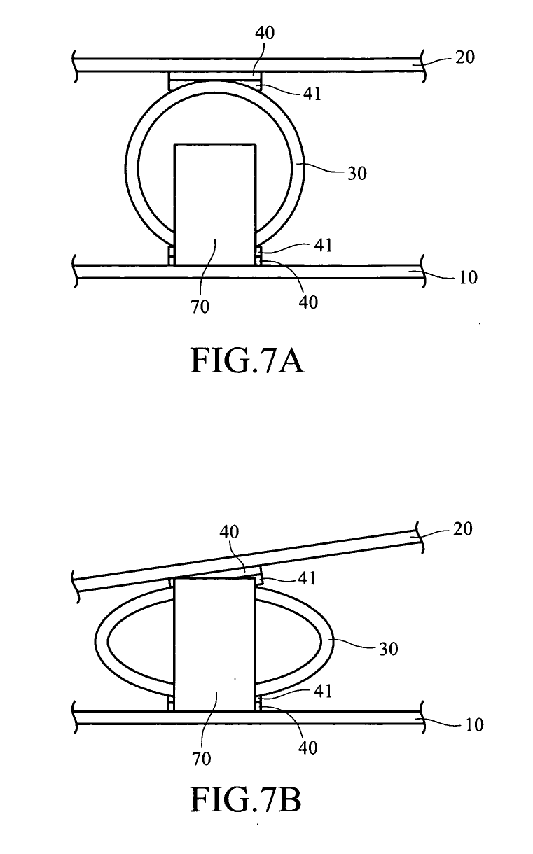

Referring to FIGS. 7A and 7B, the buffer struts 70 are made of rubber that is elastic. They are mounted onto the first baseboard 10. The top end of the buffer struts 70 is spaced from the second baseboard 20 at a predetermined distance. When the vibration amplitude occurs to the helical springs 30 and the damping elements 60, caused by the vibration source, are within the isolation and absorption range, the buffer struts 70 do not touch the second baseboard 20. In the event that the shock and/or vibration caused by the external force is excessive and beyond the bearable range of the helical springs 30 and the damping elements 60, the helical springs 30 generate a greater deformation, and the second baseboard 20 contacts the buffer struts 70. Then the buffer struts 70 can provide a buffer effect to absorb the kinetic energy and prevent the second baseboard 20 from directly hitting the first baseboard 10. Excessive deformation of the helical springs 30 can also be avoided. Hence permanent deformation caused by the elastic strain exceeding the upper limit can be prevented.

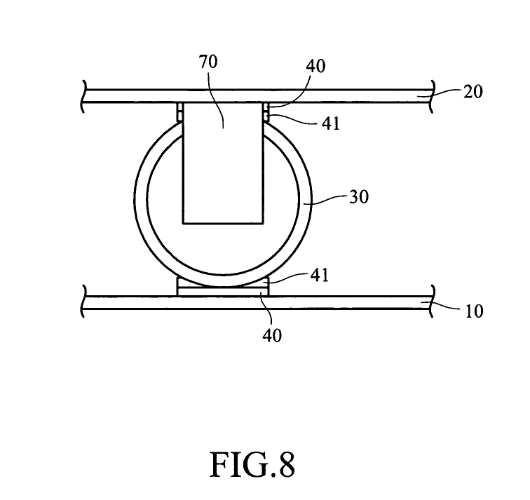

Referring to FIG. 8, the buffer struts 70 may also be mounted onto the second baseboard 20 with the front ends thereof spaced from the first baseboard 10 at a selected distance. When the vibration amplitude is excessively large, the distal ends of the buffer struts 70 touch the first baseboard 10 first, hence can prevent the first baseboard 10 from directly hitting the second baseboard 20.

In short, the conventional shock and/or vibration isolation apparatus provides shock and/or vibration isolation protection merely through elastic shock and/or vibration isolation units that have a limited damping effect, and the dynamic characteristics mainly rely on elasticity. While the elastic damping elements, thus formed, can provide a shock and/or vibration isolation effect and prevent direct shock and/or vibration, they cannot effectively dissipate kinetic energy. As a result, during the shock and/or vibration isolation process, excessive acceleration and vibration amplitude could occur to the electronic device to be protected. This shock and/or vibration isolation protection effect is not desirable. Moreover, the elastic shock and/or vibration isolation units transform the kinetic energy to elastic potential energy for storing. When the external force is absent, the elastic potential energy is transformed to kinetic energy, and a great instantaneous acceleration occurs to form a secondary impact. This directly affects the electronic device to be protected. The original object of shock and/or vibration isolation protection suffers.

By means of the invention, in addition to separating the second baseboard 20 and the first baseboard 10 by the helical springs 30, damping elements 60 are provided to dissipate the kinetic energy so that the vibration amplitude or instantaneous acceleration, resulting from shock and/or vibration of the second baseboard 20, can be greatly reduced. The damping elements 60 can further absorb the elastic potential energy released by the helical springs 30, to reduce the effect of secondary impact. This damping feature and characteristic is not known in the conventional apparatus. Moreover, the invention also provides buffer struts 70 to serve as a second level protection, to prevent the second baseboard 20 from directly hitting the first baseboard 10, when the external force exceeds the loading limit of the helical springs 30 and damping elements 60.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A shock isolation system for electronic devices, comprising:
a first baseboard;
a second baseboard located above the first baseboard at a distance;
a plurality of helical springs interposed between the first baseboard and the second baseboard having axes thereof parallel with the first baseboard and the second baseboard, and having two lateral sides anchored respectively on the first baseboard and the second baseboard, each of the helical springs being deformable radially or turnable axially in a torsional manner to generate a shock isolation effect in axial and radial directions; and
a plurality of damping elements located between the first baseboard and the second baseboard, each of the damping elements having damping characteristics to dissipate kinetic energy generated by vibration.

2. The shock isolation system for electronic devices of claim 1, wherein the first baseboard is mounted onto a vibration source to receive a vibration impact generated by the vibration source.

3. The shock isolation system for electronic devices of claim 1, wherein the second baseboard holds an electronic device.

4. The shock isolation system for electronic devices of claim 3, wherein the electronic device is a notebook computer.

5. The shock isolation system for electronic devices of claim 1 further including a plurality of holding elements which are formed in pairs corresponding to each other and located on the first baseboard and the second baseboard to hold the helical springs.

6. The shock isolation system for electronic devices of claim 5, wherein each of the holding elements has a plurality of transverse ditches mating the wire diameter of the helical springs to couple with the helical springs.

7. The shock isolation system for electronic devices of claim 1, wherein each of the damping elements includes a linkage bar and two damping rubber blocks which are located on two ends of the linkage bar and connect to the first baseboard and the second baseboard.

8. The shock isolation system for electronic devices of claim 1 further having a plurality of buffer struts which are vertically mounted onto the second baseboard and have a top end spaced from the first baseboard at a selected distance.

9. The shock isolation system for electronic devices of claim 8, wherein the buffer struts are made from rubber.

10. The shock isolation system for electronic devices of claim 1 further having a plurality of buffer struts which are mounted onto the bottom of the first baseboard and have a distal end spaced from the second baseboard at a selected distance.
